(19) United States
(12) Patent Application Publication
(10) Pub. No.: US 2026/0272201 A1
(43) Pub. Date: Sep. 17, 2026

(54) MOUNTING DEVICE

(71) Applicant: Umbra LLC, Buffalo, NY (US)

(72) Inventor: Henry HUANG, Toronto (CA)

(21) Appl. No.: 19/076,213

(22) Filed: Mar. 11, 2025

(51) Int. Cl. A47G 29/08; F16B 15/00; F16M 13/02

(52) U.S. Cl. CPC A47G 29/08; F16B 15/00; F16M 13/02

(57) ABSTRACT

A mounting device designed to be affixed to a mounting surface, such as a wall. The device having a base having a first face and a second face, a mounting protrusion extending from the first face of the base, the mounting protrusion having a shaft portion and a head portion, both portions being centered about a main central axis, three through-bores extending through the base and mounting protrusion, each opening of each through-bore being equally spaced in a circumferential manner about the central axis, three fasteners, each of the fasteners arranged to be inserted through each of the through-bores and adapted to be inserted into a mounting surface, thereby fixing the mounting device to the mounting surface, wherein the base has a portion that extends downwardly past an external surface of the head portion greater than a total height of the head portion.

### FIELD OF THE INVENTION

The present invention is related to mounting hardware, specifically a three-fastener style mounting hardware.

### BACKGROUND OF THE INVENTION

It is known that when using a fastener, such as a nail or the like, to hang a hook, other attachment device, or mounting hardware, that inserting the fastener through the hook or other attachment device and through the mounting location, e.g., a wall, at an angle, a shear force is produced and is dispersed over a larger region of the wall. By doing this, the possibility of the fastener coming out or the wall collapsing under the weight of the object is decreased. Also, the fastener's slant aids in locking it into place and serves as a reliable anchor for the mounting hardware.
Shear Force Distribution: When you drive a fastener into a mounting location, which may be drywall, at an angle, it distributes the force along the length of the fastener more efficiently than driving it straight. This is because an object hung on the fastener or on the mounting hardware hung by the fastener, applies a downward force that may to pull the fastener out. However, a fastener angled upwards has to be sheared or cut off, not just pulled out, making it harder for the object to fall. This means there is more friction between the fastener and the mounting location, which can resist the fastener from being pulled out. Friction is the resistance of motion when one object rubs against another. The greater the friction, the more force is required to move the object.
Increased Surface Area: By driving a fastener at an angle, there is a larger amount of the fastener's surface area in contact with the mounting location, e.g., drywall, etc. This increased friction provides additional resistance to the force pulling the fastener out, making it more secure. The downward force applied by the object's weight is split into two components when a fastener is driven at an angle: a component perpendicular to the fastener (which would try to pull the fastener out of a wall) and a component parallel to the fastener (which tries to shear the fastener, or slice it). The shear strength of a fastener is generally much greater than its pullout strength, so the fastener at an angle can hold more weight.
Load Transmission: When a fastener, such as a nail, is hammered in at an angle, or a screw, is driven in at an angle, it is more effective at transmitting the load into the structure. If a load is applied at the end of a fastener driven in straight, it can lever the fastener out-much easier with a nail versus a screw. However, when the fastener is at an angle, the load is transmitted along the fastener into the wall, or drywall, and the structure behind it, creating a stronger anchoring effect. This is known as the lever principle. A straight fastener can act like a lever with the fulcrum at the wall surface. A small downward force at the end can result in a large force attempting to lever the fastener out of the wall. When a fastener is driven at an angle, this lever effect is reduced, hence it's more difficult for the fastener to be levered out.

Even if a fastener is driven into a mounting location, a wall, drywall, etc., at an angle, there still is a limit to the load a single fastener can withstand. As such, known mounting hardware incorporates three (3) fasteners or four (4), each of which being equally angled about a central axis, thereby increasing the load such mounting hardware can accommodate. Essentially, it can be said that such known mounting hardware is a cantilever beam. However, such mounting hardware does not contemplate an additional component to further enhance the load capacity of such cantilever beam.

Thus, there is a long-felt need for an improved three-fastener mounting hardware that incorporates an additional component to enhance the load capacity of the mounting hardware, where such component increases the support area of the fixed end of the mounting hardware, enhances the moment of inertia of the mounting hardware, improve load distribution of the mounting hardware, and reduces shear stress at the fixed end of the mounting hardware.

### SUMMARY OF THE INVENTION

In a broad aspect, the present invention may comprise an attachment or mounting device, specifically a mounting hardware, and more specifically a three (3) fastener mounting hardware. The device generally comprises a base with a mounting protrusion extending therefrom, where the base and mounting protrusion component have three (3) through-bores extending therethrough. The three (3) through-bores are angled and equally spaced about a center axis extending through both of the base and mounting protrusion, and each of the through-bores are designed to accept a fastener therein, such that each of the fasteners exit the through-bore, through a surface of the base at an angle with orients respective ends of each of the fasteners away from the center axis. The base is a fixed end of the mounting hardware, which base is designed to extend downwardly past an external most edge of the mounting protrusion, thereby increasing the support area of the fixed end, enhancing the moment of inertia of the mounting hardware, improving load distribution of the mounting hardware, and reducing shear stress at the fixed end.

An object of the invention is to distribute the load efficiently across the device when engaged to a mounting surface. This is achieved by the angled placement of the through-bores and corresponding fasteners engaged therein, which enhances stability by allowing the fasteners to anchor firmly into the wall at an angle, i.e., in a non-perpendicular manner.

Further contemplated aspects of the present invention are disclosed by way of example, infra.

### BRIEF DESCRIPTION OF THE DRAWINGS

The invention is described in detail below with reference to the to the accompanying schematic drawings. Various embodiments are disclosed, by way of example only, in which corresponding reference symbols indicate corresponding parts, in which:

FIG. 1A generally shows a top perspective view of the present invention attached to a wall and a plurality of fixing members arranged within the invention;

FIG. 1B generally shows a bottom perspective view of the invention shown in FIG. 1A isolated;

FIG. 2 generally illustrates an exploded view of the invention shown in FIG. 1B;

FIG. 3A is a left-side elevational view of an attachment member of the invention shown in FIG. 1B;

FIG. 3B is a right-side elevational view of the attachment member of the invention shown in FIG. 3A;

FIG. 3C is top plan view of the attachment member of the invention shown in FIG. 3A;

FIG. 3D is a bottom plan view of the attachment member of the invention shown in FIG. 3A;

FIG. 4A is a perspective view of a representation of the through-bores of the invention shown in FIG. 3A;

FIG. 4B is a front elevational view of the representation shown in FIG. 4A;

FIG. 5A is a front elevation view of the attachment member of the invention shown in FIG. 3A;

FIG. 5B is a rear elevation view of the attachment member of the invention shown in FIG. 3A; and,

FIG. 6A illustrates a left side view of the invention shown in FIG. 1B; and,

FIG. 6B illustrates a front elevational view of the invention shown in FIG. 1B.

### DETAILED DESCRIPTION OF THE INVENTION

Referring now, with more particularity, to the drawings, it should be noted that the disclosed invention may comprise embodiments in various sizes, shapes, and forms. Therefore, the embodiments described herein are provided with the understanding that the present description is intended as illustrative and is not intended to limit the invention to the embodiments described herein. At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. Thus, those in the art will understand that any suitable material, now known or hereafter developed, may be used in forming the present invention described herein.

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims.

It should also be appreciated that directional terms used herein are relative to the corresponding figure being described. For example, “leftward” or “rightward”, “top” or “bottom”, are relative to the figure as illustrated on a particular sheet, therefore “leftward” is referring to the left side of an illustration as depicted.

It should be noted that the terms “fastener” and “fixing member” are intended to be synonymous and interchangeable.

Referring now to the figures, it will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

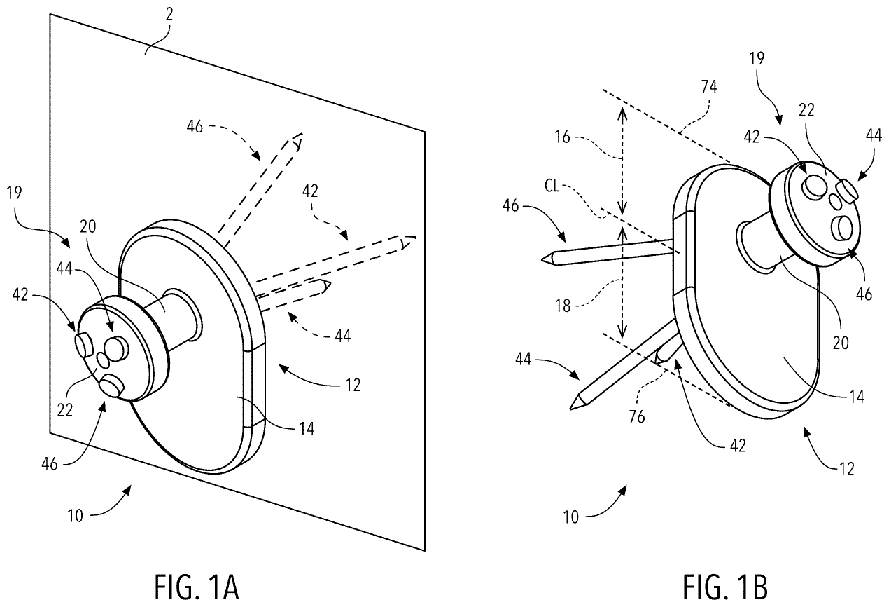

Adverting now to the drawings, FIG. 1A illustrates a perspective view of mounting device 10 affixed to wall 2. The mounting device includes attachment member 12 composed of base member 14 and mounting protrusion 19 extending therefrom. Mounting protrusion 19 comprises shaft portion 20 being directly affixed to base member 14 and head portion 22 which extends from shaft portion 20.

The device is shown secured to wall 2 using three fasteners 42, 44, and 46. These fasteners are inserted through designated through-bores, ensuring a stable and secure attachment to the wall. Fasteners 42, 44, and 46 are positioned at specific angles through their respective through-bores, such that they are inserted into wall 2 at an angle, enhancing the stability, load capacity, and dispersing shear force from a load applied to mounting protrusion 19 over a larger region of wall 2.

FIG. 1B presents a bottom perspective view of mounting device 10, highlighting the spatial arrangement of fasteners 42, 44, and 46. The attachment member 12 is detailed with the base member 14, showing its top half 16 and bottom half 18. A distance between top edge 74 and bottom edge 76 defines a total height of base member 14. Top half 16 is defined by a middle of the total height of base member 14 and top edge 74. Bottom half 18 is defined by the middle of the total height of base member 14 and bottom edge. The fasteners are design to extend through each of base member 14, shaft portion 20, and head portion 22.

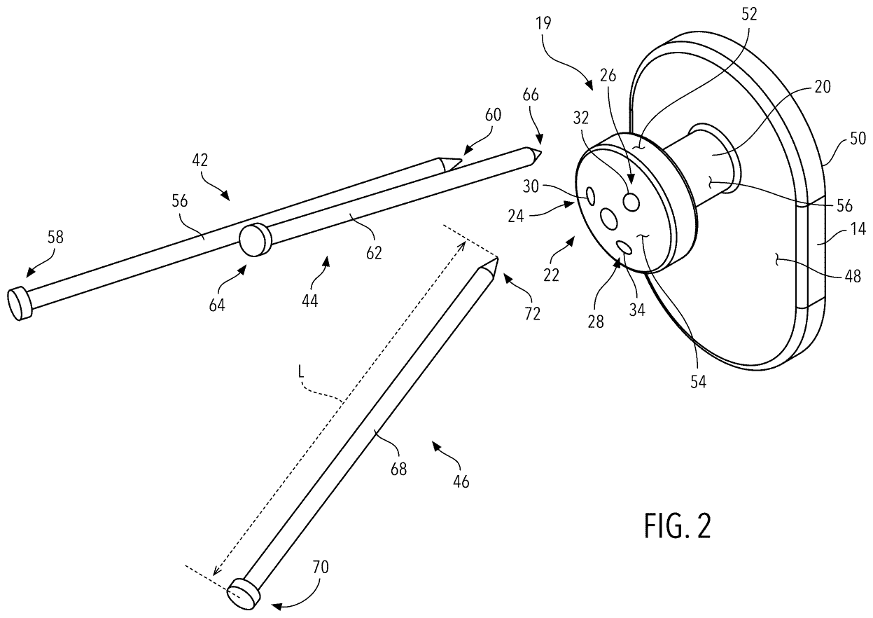

FIG. 2 provides an exploded view of mounting device 10. The attachment member includes of base member 14, which has front face 48 and rear face 50. Extending from base member 14 is mounting protrusion 19, composed of shaft portion 20 and head portion 22. The head portion is characterized by sidewall 52 and frustoconical face 54, which aids in centering the fasteners and distributing load.

Base member 14 is designed with three through-bores: first through-bore 24, second through-bore 26, and third through-bore 28. Each through-bore extends through the head and shaft portions, terminating at openings 30, 32, and 34, and another triplicate of openings disposed on rear face 50, respectively. These openings are precisely aligned to facilitate the insertion of fasteners in an equally-spaced circumferential manner.

The fasteners, comprising first fastener 42, second fastener 44, and third fastener 46, are designed to be inserted into first through-bore 24, second through-bore 26, and third through-bore 28, via openings 30, 32, and 34, respectively. Each fastener is constructed with a body, a head, and a tip. Specifically, first fastener 42 includes body 56, head 58, and tip 60, while the second fastener 44 features body 62, head 64, and tip 66. The third fastener 46 is similarly configured with body 68, head 70, and tip 72. The length the third fastener, length L, is substantially equal to respective lengths of first and second fasteners 42 and 44.

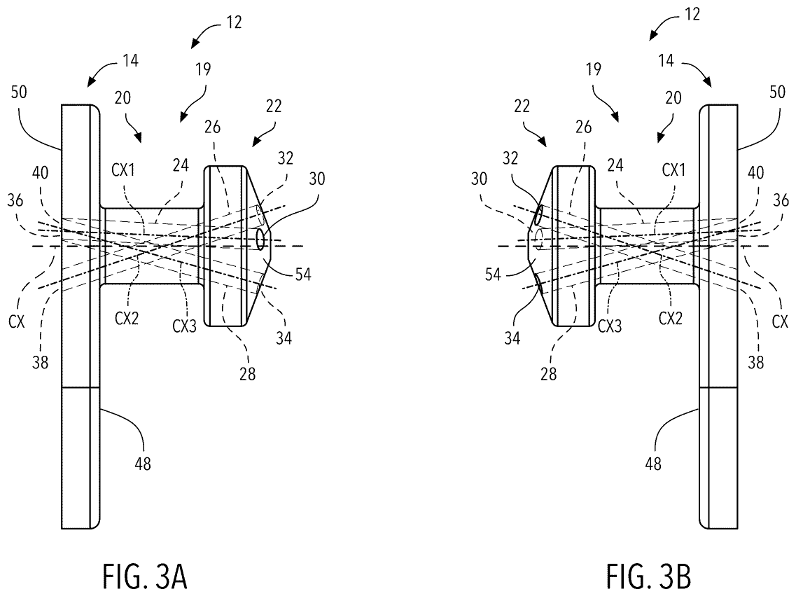

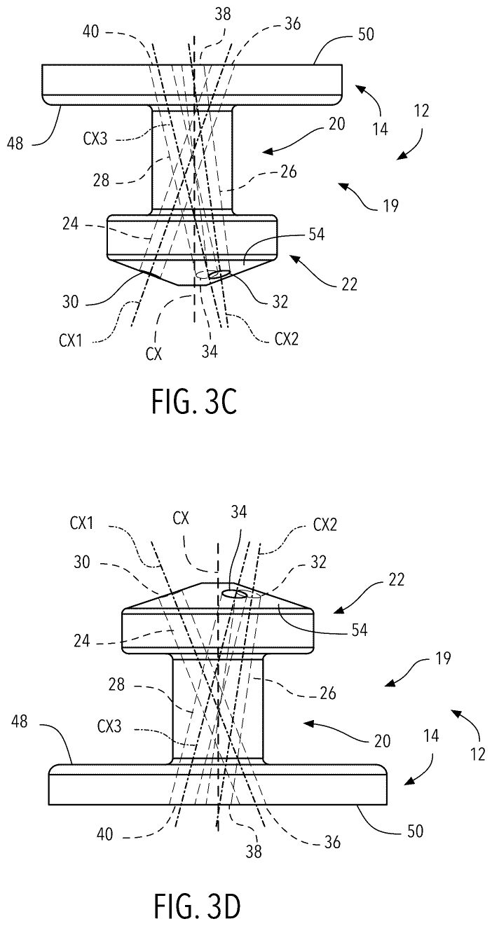

The following description is in reference to FIGS. 3A through 3D and the through-bores of attachment member 12 are illustrated in hidden lines.

FIG. 3A presents a left-side elevational view of attachment member 12, highlighting its internal structural components. Base member 14 is shown with front face 48 and rear face 50. Extending from the base member is mounting protrusion 19, which includes shaft portion 20 and head portion 22. The head portion features frustoconical face 54. Three through-bores, identified as first through-bore 24, second through-bore 26, and third through-bore 28, extend through the mounting protrusion. Each through-bore is centered around its own central axis, CX1, CX2, and CX3, respectively. Each of these central axes is equally spaced in a circumferential manner around main central axis CX such that each of openings 30, 32, and 34 of through-bore 24, 26, and 28 are equally spaced from each other and also equally spaced away from main central axis CX on frustoconical face 54.

FIG. 3B illustrates a right-side elevational view of attachment member 12. This view mirrors the structural features seen in FIG. 3A, providing a clear perspective of the alignment of through-bores 24, 26, and 28. The frustoconical face 54 of head portion 22 is visible, ensuring that each through-bore, with openings 30, 32, and 34, is designed for optimal fastener insertion. The equal circumferential spacing of central axes CX1, CX2, and CX3 around main central axis CX enhances the stability of the device when affixed to a mounting surface.

FIG. 3C offers a top plan view of the attachment member 12. The arrangement of the through-bores is shown in detail, with each of opening 30, 32, and 34 on head portion 22 precisely positioned to guide fasteners along their respective central axes, CX1, CX2, and CX3 of through-bores 24, 26, and 28.

FIG. 3D provides a bottom plan view of attachment member 12. The exits, 36, 38, and 40, of the through-bores are shown on rear face 50 of base member 14. This view emphasizes the precise alignment and spacing of the through-bores, facilitating the insertion of fasteners at angles that maximize stability and load-bearing capacity, while also dispersing shear force (of fasteners inserted therein) over a larger region of a respective mounting surface, e.g., a wall.

In FIGS. 3A through 3D, each of through-bores 24, 26, and 28 is designed such that its central axis (CX1, CX2, and CX3, respectively) is non-parallel with respect to the main central axis CX. This non-parallel configuration is achieved by angling each through-bore outwardly from the main central axis CX, such that each of through-bores 24, 26, and 28 intersect main central axis CX, creating a radial alignment that enhances the stability of the mounting device.

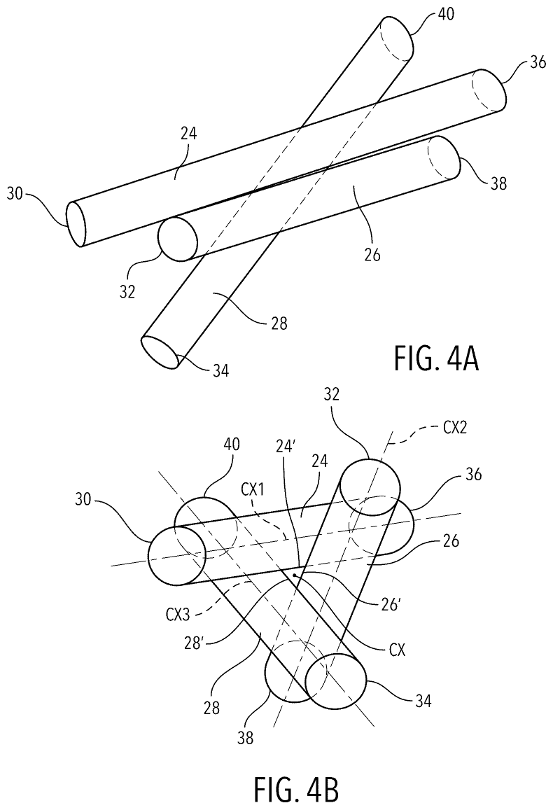

FIG. 4A provides a representative perspective view of through-bores 24, 26, and 28, as disposed within attachment member 12 shown in FIGS. 3A through 3D, illustrating their spatial arrangement and orientation. Each through-bore is depicted as a cylindrical passage with respective openings, i.e., distinct openings and exits. First through-bore 24 has opening 30 and exit 36, second through-bore 26 has opening 32 and exit 38, and third through-bore 28 has opening 34 and exit 40. This view highlights how each through-bore is angled relative to one another, allowing for non-parallel alignment with respect to the main central axis, which is central to the overall configuration.

FIG. 4B is a front elevational view of the representation in FIG. 4A, emphasizing the geometric relationship between the central axes of the through-bores. The central axes, CX1, CX2, and CX3, of through-bores 24, 26, and 28, respectively, are shown in relation to one another. Each axis is angled and equally spaced in a circumferential manner around main central axis CX. This arrangement ensures that the through-bores are non-parallel and strategically positioned to optimize the insertion and anchoring of fasteners.

It should be noted that the central axes, CX1, CX2, and CX3, of through-bores 24, 26, and 28, define respective centers of the openings of each through-bore. In other words, central axis CX1 defines the center of both opening 30 and exit 36 of through-bore 24, central axis CX2 defines the center of both opening 32 and exit 38 of through-bore 26, and central axis CX3 defines the center of both opening 34 and exit 40 of through-bore 28.

The configuration depicted in FIGS. 4A and 4B illustrates how the non-parallel arrangement ensures that when fasteners are inserted into the through-bores, they extend outwardly at an angle rather than directly parallel to main central axis CX. This design distributes the load more evenly across the fasteners, reducing stress at any single point, enhances the device's capacity to resist shear forces and minimizing the risk of the mounting device becoming loose or detached from the wall.

FIG. 4B also represents boundaries of a prism-shaped section disposed within the mounting protrusion and the base. As shown, each of through-bores 24, 26, and 28, have inner surface/wall 24′, 26′, 28′, respectively. Inner surface/wall 24′, 26′, 28′, at a substantially centered location between openings 30, 32, 34, and exits 36, 38, and 40, define the boundaries of a prism-shaped section of the mounting protrusion and the base which is centered about main central axis CX. It should be appreciated that this prism-shaped section extends from the outermost edge of the head portion of the mounting protrusion (e.g., frustoconical face 54 of head portion 22 of mounting protrusion 19) to the rear face of the base (e.g., rear face 50 of base 14). As shown, through-bores 24, 26 and 28 overlap but do not intersect one another within the mounting protrusion and base, due to exits 36, 38, and 40 being rotated about main central axis CX relative to openings 30, 32, 34. The prism-shaped section has an external perimeter that is significantly less an external perimeter of each of openings 30, 32, 34, and exits 36, 38, and 40, e.g., at least 100% less.

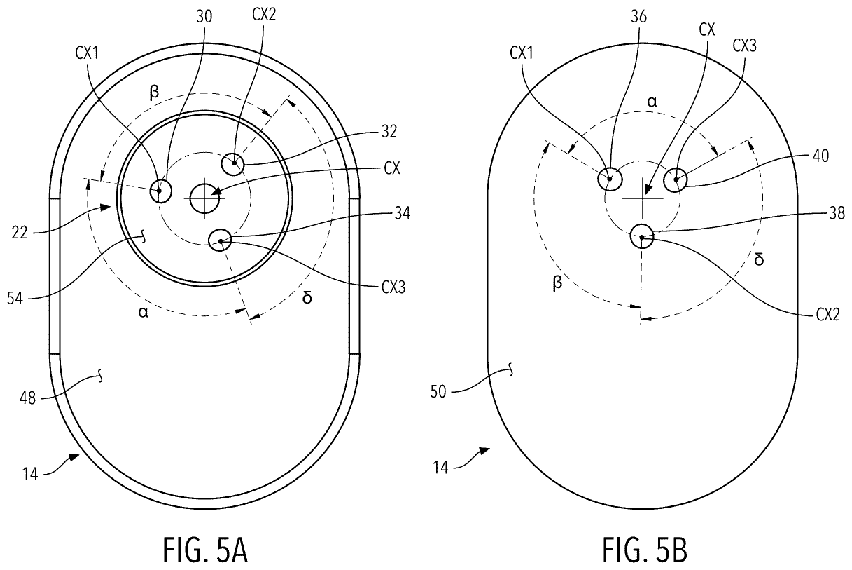

FIG. 5A provides a front elevational view of base member 14. Head portion 22, with frustoconical face 54, presents three through-bores, 24, 26, and 28, each with distinct openings 30, 32, and 34. These openings are positioned around main central axis CX, with central axes CX1, CX2, and CX3 illustrating a substantial center of each opening, where each opening is equally spaced at angles α, β, and δ, respectively. This equal angular spacing ensures that when fasteners are inserted, the load is balanced evenly across the mounting device.

FIG. 5B illustrates a rear elevational view of base member 14. Here, exits 36, 38, and 40 of through-bores 24, 26, and 28 are depicted within rear face 50. These exits are positioned around main central axis CX, with central axes CX1, CX2, and CX3 illustrating a substantial center of each exit, where each exit is equally spaced at angles α, β, and δ, respectively. These exits are strategically positioned closer to main central axis CX compared to the openings on the front face in FIG. 5A. This inward rotation and convergence create a tapered alignment of through-bores (See through-bores 24, 26, and 28 in FIG. 4A) from front to back. This configuration enhances the anchoring stability by distributing forces more effectively towards the central axis.

The design of the present invention, as illustratively depicted in FIGS. 5A and 5B, with exits 36, 38, and 40 positioned in a first arrangement circumferentially about main central axis CX and openings 30, 32, and 34 positioned in a second arrangement circumferentially about main central axis CX provides several advantages. By rotating the positions of the openings and exits about the main central axis, the mounting device achieves optimal force distribution, making it highly effective for securely attaching objects to a surface and further enhances shear resistance. Further, FIGS. 5A and 5B, depict how each opening (e.g., openings 30, 32, and 34 and exits 36, 38, and 40, collectively the openings) of through-bores 24, 26, and 28 are equally spaced in a circumferential manner, e.g., angles α, β, and δ, about main central axis CX, but each opening (e.g., openings 30, 32, and 34 and exits 36, 38, and 40, collectively the openings) of through-bores 24, 26, and 28, are not arranged at equal distances from main central axis CX, openings 30, 32, and 34 are all arranged at a first distance from main central axis CX and exits 36, 38, and 40 are all arranged at a second distance from main central axis CX, but the first distance is greater than the second distance.

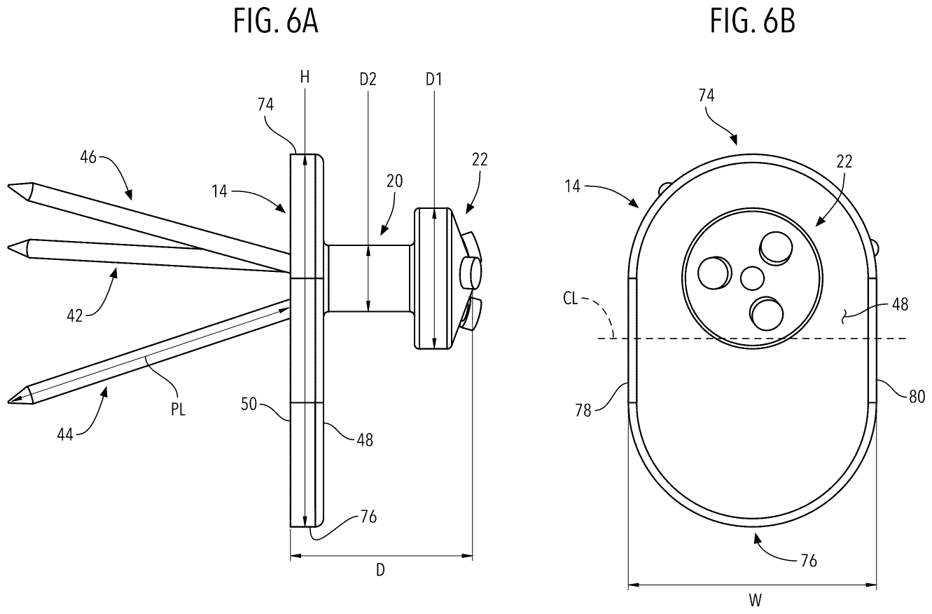

In reference to FIGS. 6A and 6B, base member 14 is shown with top edge 74, bottom edge 76, first side edge 78 and second side edge 80. Extending from the base member is shaft portion 20 of the mounting protrusion, which leads to head portion 22. Notably, diameter D2 of the shaft portion is smaller than diameter D1 of the head portion. Height H of base member 14 is defined by top edge 74 and bottom edge 76. Width W of base member 14 is defined by first side edge 78 and second side edge 80. Depth D is the combined depth of base member 14, shaft portion 20, and head portion 22. In a preferred embodiment: D>W; D>H; and, D1>D2.

As shown in FIG. 6A, third fastener 44 has protruding length PL from its respective tip to rear face 50, which is the portion of third fastener 44 that is inserted into a mounting surface, e.g., a wall. Protruding length PL is greater than combined depth D of base member 14, shaft portion 20, and head portion 22.

As shown in FIG. 1B and FIG. 6B, center line CL is a center between top edge 74 and bottom edge 76 and bifurcates top portion 16 and bottom portion 18 of base member 14. Mounting protrusion 19 extends from top portion 16 and is proximate top edge 76, i.e., is closer to top edge 74 than bottom edge 76.

FIGS. 6A and 6B illustrate how base member 14 extends below the point where shaft portion 20 attaches, providing a greater portion of the base below this junction. This design increases the support area at a fixed end, e.g., rear face 50, to support a load applied downwardly onto a free end, e.g., one or more of shaft portion 20 or head portion 22, which is essentially a form of a cantilever beam. Due to the portion of base member 14 that extends below the point where shaft portion 20 attaches, e.g., all of bottom portion 18 shown in FIG. 1B and a portion of top portion 16 below shaft portion 20 in FIG. 1B, the load capacity of the present invention is increase for the reasons below.
Increased Support Area: the aforementioned portion of the base member provides a larger area of support at the fixed end, distributing the load more evenly and reducing stress concentrations.
Enhanced Moment of Inertia: the aforementioned portion of the base member can increase the moment of inertia, making the beam more resistant to bending and deflection.
Improved Load Distribution: the aforementioned portion of the base member helps distribute the applied load more effectively along the length of the cantilever, reducing the bending moment at any single point.
Reinforcement and Stability: the aforementioned portion of the base member acts as a reinforcement, providing additional stability and rigidity to the cantilever, making it less prone to bending or failure.
Reduced Shear Stress: the aforementioned portion of the base member can help in reducing shear stress at the fixed end, which is a common failure point in cantilever beams.

### EXAMPLES

The following clauses reference the reference numerals shown in the drawings and are to not to be considered restrictive on the scope of the appending claims. The following clauses are intended to be illustrative examples of possible embodiments of the present invention.

### Clause 1

An attachment device (10) arranged to be secured to a wall (W), comprising: three fixing members (42, 44, 46); and, an attachment member (12), comprising: a flat base member (14) having a top half (16) and a bottom half (18); a cylindrical middle member (20); a head member (22), wherein the cylindrical middle member (20) and the head member (22) extends from the top half (16) of the base member (14), and, wherein a height (H1) and width (W1) of the base member (14) are each greater than a diameter (D) of the head member (22); and, three through-bores (24, 26, 28) extending through the head member (22), the cylindrical middle member (20) and the base member (14), each of the three through-bores (24, 26, 28) having an opening (30, 32, 34) and an exit (36, 38, 40), the three openings (30, 32, 34) defining a first equilateral triangle and the three exits (36, 38, 40) defining a second equilateral triangle, the three through-bores (24, 26, 28) arranged to receive the fixing members (42, 44, 46).

### Clause 2

The attachment device (10) arranged to be secured to a wall (2) recited in Clause 1, where each of the fixing members (42, 44, 46) comprises a body (56, 62, 68) arranged between a head (58, 64, 70) and a tip (60, 66, 72).

### Clause 3

A mounting device (10), comprising: a base (14) having a first face (48) and a second face (50); a mounting protrusion (19) extending from the first face (48) of the base (14), the mounting protrusion (19) having a shaft portion (20) and a head portion (22), both portions being centered about a main central axis (CX); three through-bores (24, 26, 28) extending through the base (14) and mounting protrusion (19), each opening (30, 32, 34, 36, 38, 40) of each through-bore (24, 26, 28) being equally spaced in a circumferential manner about the central axis (CX); and, three fasteners (42, 44, 46), each of the fasteners (42, 44, 46) arranged to be inserted through each of the through-bores (24, 26, 28) and adapted to be inserted into a mounting surface (W), thereby fixing the mounting device (10) to the mounting surface (W), wherein the base (14) has a portion that extends downwardly past an external surface (52) of the head portion (22) greater than a total height of the head portion (22).

### Clause 4

The mounting device (10) of Clause 3, wherein: a first (24), second (26), and third through-bore (28) of the three through-bores (24, 26, 28) are centered about respective first (CX1), second (CX2), and third through-bore central axis (CX3) and each of the through-bore central axes (CX1, CX2, CX3) are non-parallel with respect to the main central axis (CX).

### Clause 5

The mounting device (10) of Clause 3, wherein: the base member (14) has a top edge (74), a bottom edge (76), a first side edge (78), and a second side edge (80), the mounting protrusion (19) being proximate the top edge (74) and equally spaced between the side edges (78, 80).

### Clause 6

The mounting device (10) of Clause 3, wherein each of the fasteners (42, 44, 46) has a head (58, 64, 70), a body (56, 62, 68), and a tip (60, 66, 72), wherein each head (58, 64, 70) of each of the fasteners (42, 44, 46) engages a surface (54) of the head portion (22) of the mounting protrusion (19).

### Clause 7

The mounting device (10) of Clause 3, wherein the base member (14) has a height (H) which is greater than a diameter (D1) of the head portion (22) of the mounting protrusion (19), and wherein the base (14) member has a width (W) which is greater than the diameter (D1) of the head portion (22) of the mounting protrusion (19).

### Clause 8

The mounting device (10) of Clause 3, wherein the mounting protrusion (19) and the base (14) have a combined depth (D) which is at least less than half of a total length (L) of each of the three fasteners (42, 44, 46).

### Clause 9

The mounting device of Clause 8, wherein the combined depth (D) is approximately less than a third of the total length (L) of each of the three fasteners (42, 44, 46).

### Clause 10

The mounting device (10) of Clause 3, wherein: the mounting protrusion (19) and the base (14) have a combined depth (D); each of the three fasteners (42, 44, 46) protrude away from the second face (50) of the base (14) when inserted into each of the through-bores (24, 26, 28) at a length (PL) greater than the combined depth (D).

### Clause 11

The mounting device (10) of Clause 3, wherein the shaft portion (20) of the mounting protrusion (19) has a first diameter (D2) and the head portion (22) of the mounting protrusion (19) has a second diameter (D1), the second diameter (D1) being greater than the first diameter (D2).

### Clause 12

The mounting device (10) of Clause 11, wherein the first diameter (D2) is at least less than half of the second diameter (D1).

### Clause 13

A mounting device (10), comprising: a base (14) having a first face (48) and a second face (50); a mounting protrusion (19) extending from the first face (48) of the base (14), the mounting protrusion (19) having a shaft portion (20) and a head portion (22), both portions being centered about a main central axis (CX); three through-bores (24, 26, 28) extending through the base (14) and mounting protrusion (19), each opening (30, 32, 34, 36, 38, 40) of each through-bore (24, 26, 28) being equally spaced in a circumferential manner about the central axis (CX); and, three fasteners (42, 44, 46), each of the fasteners (42, 44, 46) arranged to be inserted through each of the through-bores (24, 26, 28) and adapted to be inserted into a mounting surface (W), thereby fixing the mounting device (10) to the mounting surface (W), wherein the three through-bores (24, 26, 28) overlap but do not intersect one another within the mounting protrusion (19) and the base (14) such that respective surfaces (24′, 26′, 28′) of each of the three through-bores (24, 26, 28) define the boundaries of a prism-shaped section of the mounting protrusion (19) and the base (14) centered about the main central axis (CX).

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

### LIST OF REFERENCE NUMERALS

2 Wall
10 Mounting device
12 Attachment member
14 Base member
16 Top half of base member 14
18 Bottom half of base member 14
19 Mounting protrusion
20 Shaft portion
22 Head portion
24 First through-bore
24′ Inner surface/wall of first through-bore 24
26 Second through-bore
26′ Inner surface/wall of second through-bore 26
28 Third through-bore
28′ Inner surface/wall of third through-bore 28
30 Opening of first through-bore 24
32 Opening of second through-bore 26
34 Opening of third through-bore 28
36 Exit of first through-bore 24
38 Exit of second through-bore 26
40 Exit of third through-bore 28
42 First fastener
44 Second fastener
46 Third fastener
48 Front face of base member 14
50 Rear face of base member 14
52 Sidewall of head portion 22
54 Frustoconical face of head portion 22
56 Body of first fastener 42
58 Head of first fastener 42
60 Tip of first fastener 42
62 Body of second fastener 44
64 Head of second fastener 44
66 Tip of second fastener 44
68 Body of third fastener 46
70 Head of third fastener 46
72 Tip of third fastener 46
74 Top edge
76 Bottom edge
78 First side edge
80 Second side edge
CL Center line
CX Main central axis
CX1 Central axis of first through-bore 24
CX2 Central axis of second through-bore 26
CX3 Central axis of third through-bore 28
D Depth of attachment member 12
D1 Diameter of head portion 22
D2 Diameter of shaft portion 20
H Height of base member 14
L Length of third fastener 46
PD Proximity diameter
PL Protruding length of
W Width of base member 14
α Angle
β Angle
δ Angle

What is claimed is:

1. A mounting device, comprising:
a base having a first face and a second face;
a mounting protrusion extending from the first face of the base, the mounting protrusion having a shaft portion and a head portion, both portions being centered about a main central axis;
three through-bores extending through the base and mounting protrusion, each opening of each through-bore being equally spaced in a circumferential manner about the central axis; and,
three fasteners, each of the fasteners arranged to be inserted through each of the through-bores and adapted to be inserted into a mounting surface, thereby fixing the mounting device to the mounting surface, wherein the base has a portion that extends downwardly past an external surface of the head portion greater than a total height of the head portion.

2. The mounting device recited in claim 1, wherein:
a first, second, and third through-bore of the three through-bores are centered about respective first, second, and third through-bore central axis and each of the through-bore central axes are non-parallel with respect to the main central axis.

3. The mounting device recited in claim 1, wherein the base member has a top edge, a bottom edge, a first side edge, and a second side edge, the mounting protrusion being proximate the top edge and equally spaced between the side edges.

4. The mounting device recited in claim 1, wherein each of the fasteners has a head, a body, and a tip, wherein each head of each of the fasteners engages a surface of the head portion of the mounting protrusion.

5. The mounting device recited in claim 1, wherein the base member has a height which is greater than a diameter of the head portion of the mounting protrusion, and wherein the base member has a width which is greater than the diameter of the head portion of the mounting protrusion.

6. The mounting device recited in claim 1, wherein the mounting protrusion and the base have a combined depth which is at least less than half of a total length of each of the three fasteners.

7. The mounting device recited in claim 6, wherein the combined depth is approximately less than a third of the total length of each of the three fasteners.

8. The mounting device recited in claim 1, wherein:
the mounting protrusion and the base have a combined depth; and,
each of the three fasteners protrude away from the second face of the base when inserted into each of the through-bores at a length greater than the combined depth.

9. The mounting device recited in claim 1, wherein:
the shaft portion of the mounting protrusion has a first diameter;
the head portion of the mounting protrusion has a second diameter; and,
the second diameter being greater than the first diameter.

10. The mounting device recited in claim 9, wherein the first diameter is at least less than half of the second diameter.

11. A mounting device, comprising:
a base having a first face and a second face, the base including a top edge, a bottom edge, a first side edge, and a second side edge;
a mounting protrusion extending from the first face of the base, proximate the top edge and equally spaced between the side edges, the mounting protrusion having a shaft portion and a head portion, both portions being centered about a main central axis;
three through-bores extending through the base and mounting protrusion, each opening of each through-bore being equally spaced in a circumferential manner about the central axis; and,
three fasteners, each of the fasteners arranged to be inserted through each of the through-bores and adapted to be inserted into a mounting surface, thereby fixing the mounting device to the mounting surface, wherein each fastener comprises a head, a body, and a tip, with each head engaging a surface of the head portion of the mounting protrusion;
wherein the three through-bore comprise a first, second, and third through-bore, the first, second, and third through-bore are each centered about respective first, second, and third through-bore central axes, each through-bore central axis being non-parallel with respect to the main central axis;
wherein the base has a portion that extends downwardly past an external surface of the head portion greater than a total height of the head portion.

12. The mounting device recited in claim 11, wherein the mounting protrusion and the base have a combined depth being at least less than half of a total length of each of the three fasteners.

13. The mounting device recited in claim 11, wherein:
the mounting protrusion and the base have a combined depth;
each of the three fasteners protrude away from the second face of the base when inserted into each of the through-bores at a length greater than the combined depth.

14. A mounting device, comprising:
a base having a first face and a second face;
a mounting protrusion extending from the first face of the base, the mounting protrusion having a shaft portion and a head portion, both portions being centered about a main central axis;
three through-bores extending through the base and mounting protrusion, each opening of each through-bore being equally spaced in a circumferential manner about the central axis; and,
three fasteners, each of the fasteners arranged to be inserted through each of the through-bores and adapted to be inserted into a mounting surface, thereby fixing the mounting device to the mounting surface,
wherein the three through-bores overlap but do not intersect one another within the mounting protrusion and the base such that respective surfaces of each of the three through-bores define the boundaries of a prism-shaped section of the mounting protrusion centered about the main central axis.

15. The mounting device recited in claim 14, wherein the base has a portion that extends downwardly past an external surface of the head portion greater than a total height of the head portion.

16. The mounting device recited in claim 14, wherein:
a first, second, and third through-bore of the three through-bores are centered about respective first, second, and third through-bore central axis and each of the through-bore central axes are non-parallel with respect to the main central axis.

17. The mounting device recited in claim 14, wherein:
the base member has a top edge, a bottom edge, a first side edge, and a second side edge, the mounting protrusion being proximate the top edge and equally spaced between the side edges.

18. The mounting device recited in claim 14, wherein the base member has a height which is greater than a diameter of the head portion of the mounting protrusion, and wherein the base member has a width which is greater than the diameter of the head portion of the mounting protrusion.

19. The mounting device recited in claim 14, wherein:
the shaft portion of the mounting protrusion has a first diameter;
the head portion of the mounting protrusion has a second diameter;
the second diameter being greater than the first diameter;
the base member has a height which is greater than both the first and second diameters; and,
the base member has a width which is greater than both the first and second diameters.

20. The mounting device recited in claim 14, wherein each of the fasteners has a head, a body, and a tip, wherein each head of each of the fasteners engages a surface of the head portion of the mounting protrusion.
